(19) United States
(12) Patent Application Publication
(10) Pub. No.: US 2019/0057430 A1
(43) Pub. Date: Feb. 21, 2019

(54) METHOD AND SYSTEM FOR CLUSTERING PRODUCTS IN AN ELECTRONIC COMMERCE ENVIRONMENT

(71) Applicant: RetailCommon Inc., Toronto (CA)

(72) Inventors: Qi (Nick) ZHU, Toronto (CA); Alishan LADHANI, Toronto (CA); Gillian CHESNAIS, Toronto (CA)

(21) Appl. No.: 16/103,236

(22) Filed: Aug. 14, 2018

Related U.S. Application Data
(60) Provisional application No. 62/546,599, filed on Aug. 17, 2017.

(51) Int. Cl. G06Q 30/06; G06K 9/62

(52) U.S. Cl. CPC G06Q 30/0629; G06K 9/6261; G06K 9/6222

(57) ABSTRACT

A method and system for clustering products by determining a similarity of the products based on their characteristics. Based on the similarity of the products, an n-space mapping can be generated. The n-space mapping can then be used to reflect how products are clustered together based on similarity propagation.

### CROSS-REFERENCE TO RELATED APPLICATIONS

This application claims the benefit of priority of U.S. Provisional Patent Application No. 62/546,599 filed Aug. 17, 2017 which is hereby incorporated by reference.

### FIELD OF THE DISCLOSURE

The disclosure is directed generally at electronic commerce, and more specifically, at clustering products in an electronic commerce environment.

### BACKGROUND OF THE DISCLOSURE

Electronic commerce (e-commerce) has been a growing field for many years. Many retailers now offer both a store front location and the ability for customers to purchase items online. In some cases, retailers may only have an online presence. Instead of heading to a retail store, customers can either stay at home to make purchases or can purchase on their mobile devices without having to visit a retail store.

With the creation of e-commerce websites, customers are now also able to check prices of identical products at different merchants on their mobile devices. The display of this requires the collection of product information from merchants which can be a huge undertaking. The customers can then find the best price for a specific item based on the data collected. As the e-commerce market continues to grow, new innovation continues to be developed to assist the e-commerce market.

Therefore, there is provided a novel method and system for clustering products in an e-commerce environment.

### SUMMARY OF THE DISCLOSURE

The disclosure is directed at a method and system for clustering products in an electronic commerce environment. By clustering products, searching can be improved when users are attempting to learn about specific products along with any products similar to the one they are researching. In one embodiment, products can be clustered based on a set of characteristics using a comparison methodology and then the generation of a set of locality sensitive hash values based on the comparison. In one embodiment, the hash values may be calculated by the comparison methodology, however, in another embodiment, the hash values may be calculated via machine learning after a certain number of comparisons have been completed. These hash values can then be mapped into an n-dimensional virtual mapping space with n presenting the number of characteristics that are included within the set of characteristics.

After a set of hash values are mapped (for example, some comparison has been completed), rather than having new products compared with each of the previously compared products, the new products can be placed onto the n-dimensional virtual mapping space with its associated hash values. Similar products can be retrieved by calculating the distance originating from this given product thus avoiding unnecessary comparisons with dissimilar products.

In one aspect, there is provided a method of cluster products in an electronic commerce environment including retrieving product information, in the form of a set of characteristics, from different merchants within an electronic commerce environment. It is assumed that the product information being retrieved from these relate to similar or comparable products such as, but not limited to, televisions, furniture, apparel etc. Product information relating to more than one product can be retrieved from a single merchant. For instance, a merchant typically sells more than one television either differing by size or manufacturer. In one embodiment, the product information from at least two similar products are compared together using a comparing methodology. The comparison methodology preferably yields a numerical value representing how similar the two products are, preferably on a characteristic by characteristic basis. A set of numerical values are obtained (representing the similarity/difference) between the two products being compared and a mapping of the two products in an n-dimensional mapping space can be performed.

In one aspect of the disclosure, there is provided a method of clustering a plurality of products in an electronic commerce (e-commerce) environment including comparing a set of characteristics associated with a first product with a set of characteristics of each of the other plurality of products; determining a set of locality sensitive hash values for the first product based on the set of characteristics of the other plurality of products; and mapping the first product based on the set of locality sensitive hash values on a n-dimensional mapping space; wherein n is equal to a number of characteristics in the set of characteristics.

In another aspect, comparing a set of characteristics includes comparing each of the set of characteristics using a Jaccard comparison or a Jaccard Index. In a further aspect, before comparing a set of characteristics, a request for the first product to be searched is received. In another aspect, after receiving the request, the set of characteristics of each of the other plurality of products is retrieved. In a further aspect, retrieving the set of characteristics includes retrieving the set of characteristics from a set of merchant servers. In another aspect, retrieving the set of characteristics includes retrieving the set of characteristics from a database.

In another aspect of the disclosure, there is provided a system for clustering a plurality of products in an electronic commerce (e-commerce) environment including a central processing unit including a set of modules, the set of modules including: a communication module for communicating with users and merchants; a clustering module for comparing a product with the plurality of products to generate a set of locality sensitive hash values and to map the set of locality sensitive hash values to an n-dimensional space mapping.

In another aspect, there is provided a display module for displaying search results to a user.

### DESCRIPTION OF THE DRAWINGS

Embodiments of the present disclosure will now be described, by way of example only, with reference to the attached Figures.

FIG. 1 is a schematic diagram of a system for clustering products in an electronic commerce environment;

FIG. 2 is a schematic diagram of a processing system for use in clustering products in an electronic commerce environment;

FIG. 3 is a flowchart outlining a method of clustering products in an electronic commerce environment;

FIG. 4 is a table showing different products available from different merchants;

FIG. 5 is a table showing a plurality of locality sensitive hash values; and

FIG. 6 is an example of a 4-space mapping.

### DETAILED DESCRIPTION OF THE EMBODIMENTS

The disclosure is directed at a method and system for clustering products in an electronic commerce (e-commerce) environment. In one embodiment, by clustering products, searching can be improved when users are attempting to learn about specific products. Along with showing the specific product the user is interested in, other products similar to the one they are researching may be displayed due to the clustering of products. The method and system of the disclosure is typically implemented as a back-end system that enables improved searching and reporting. The method and system of the disclosure also provide an advantage over current systems in that when a new product comes to the market, the new product only needs to be placed onto a n-dimensional mapping space where previously compared products reside in order to determine the similarity or difference between the new product and any previously compared product since the distance between products in the n-dimensional space approximates the similarity between products.

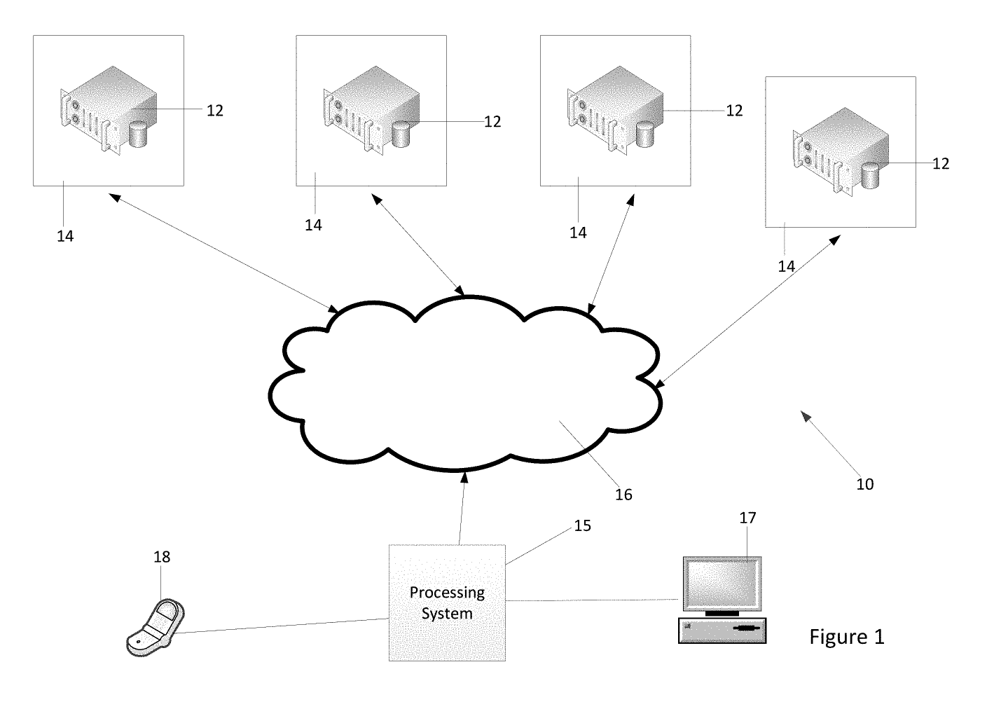

Turning to FIG. 1, a system for clustering products in an e-commerce environment is shown. The clustering system 10 includes a processing system (or memory component) 15 that communicates with a plurality of servers 12. Each server 12 may represent a merchant 14 that sells products. In one example, the products may be televisions (TVs) and the merchants are stores that sell electronics, such as, but not limited to, BestBuy®, Walmart®, Sears® or small local electronics stores. As will be understood, the products may be any product that is typically sold within a retail, or e-commerce, environment and the merchants may be any merchant that sells that type of product.

The processing system 15 retrieves information from each of the servers 12, such as, a listing of products along with a set of characteristics associated with those products in order to be able to cluster the products. In one embodiment, the set of characteristics may include, but is not limited to, name, description, price, manufacturer, UPC code or an image relating to a product. As will be understood, each server 12 may include more than one product that can be included in the listing of products or information retrieved by the processing system 15. Communication between the processing system 15 and the servers 12 is preferably performed using a wireless communication protocol, such as via the Internet 16. As such, the merchants may be located anywhere within the world, although, in a preferred embodiment, depending on the product, the locations of the merchants may be selected such that delivery of the product to the consumer is possible. A user can access the processing system 15 (or a listing of products) via a mobile device 18 such as a smartphone or a tablet. The user may also be able to access the system 10 via a desktop computer 17.

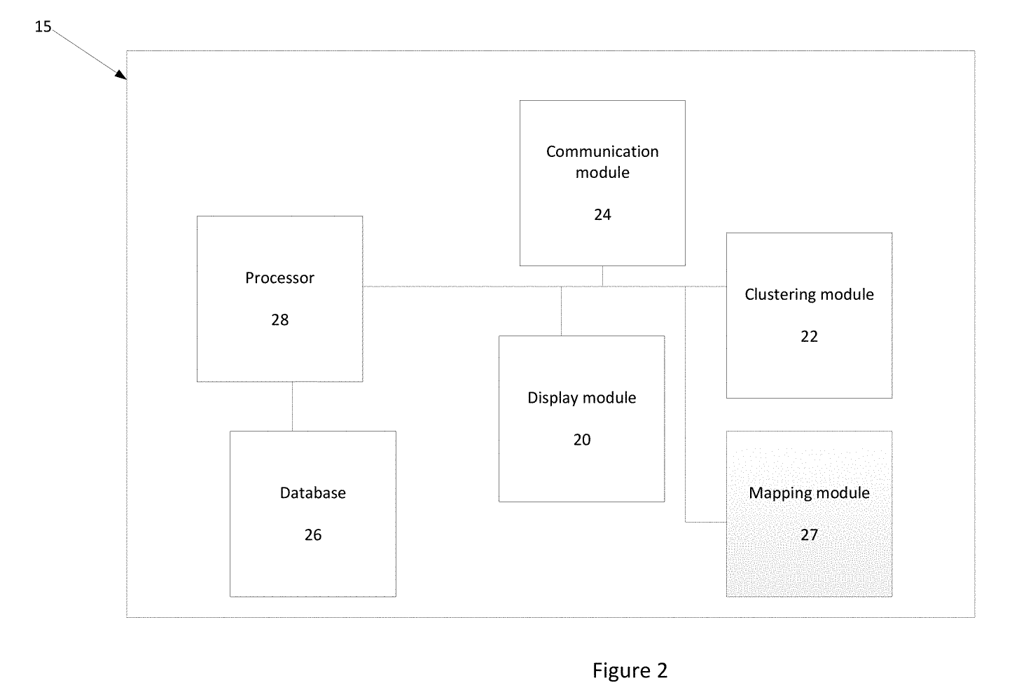

Turning to FIG. 2, a schematic diagram of the processing system 15 is shown. Within the processing system 15 are a set of modules for performing the clustering of products in an e-commerce environment among other functionality. It will be understood that the processing system 15 may include other components that may be necessary for the processing system to operate or function. In the preferred embodiment, the processing system 15 includes a display module 20, a clustering module 22, a communication module 24, a database 26 for storing the results from the clustering module 22 and a processor 28.

The display module 20 is used to communicate with the mobile device 18 or desktop computer 17 to display search information to the user such as the results of a search on a product and similar products. The search may also be focussed on a specific product and the price that each merchant may be selling the specific (and similar) products that the user, or consumer, is interested in. In another embodiment, this search information may be based on a clustering of products within an electronic commerce environment.

In another embodiment, communication between the mobile device 18 or desktop computer 17, herein after referred to by the mobile device 18, and the processing system 15 may be performed by the communication module 24 with the display module 20 providing a graphical user interface (GUI) to be displayed on the device 18. The communication module 24 may include apparatus or components to communicate with the different servers 12 to retrieve product information (and/or a set of characteristics associated with that product or those products) such that a clustering of the products may be performed. The retrieval of the product information may be performed when requested by a user via the mobile device 18 (or the desktop computer 17). The retrieval or product information may also be retrieved on a predetermined time basis such as to retrieve product information each month from the merchants in order to keep the database 26 up to date with new products being sold by merchants. Although shown as being part of the processing system 15, the database may also be located remotely and accessed by the processing system 15, when needed.

In another embodiment, the processing system 15 may continuously poll the servers 12 to determine when new products are being sold by a merchant that relate to any clustering that has been previously performed. In some embodiments, the database 26 may also store the results from previous clusterings that have already been performed. These may then be retrieved by the processor 28 when requested by a user via the mobile device 18 or desktop computer 17.

The clustering module 22 performs comparisons of the retrieved product information in order to cluster the products. In some cases, the comparison may be based on a new product. Initially, in one embodiment, when a new clustering is being performed, each of the products (in the database) are compared with the new, or single, product. As such, the new product is used as a reference between all of the products to be compared (or stored in the database). Alternatively, the new product may be assigned hash values indicating its similarity with other previously stored products based on the comparisons. The clustering module 22 may then map the new product (based on the hash values) to a n-dimensional virtual mapping space. This reduces the number of comparisons needed to generate a relationship of the similarities and differences between these products. The results of the clustering may then be stored in the database 26. Alternatively, the mapping may be performed or generated by a mapping module 27.

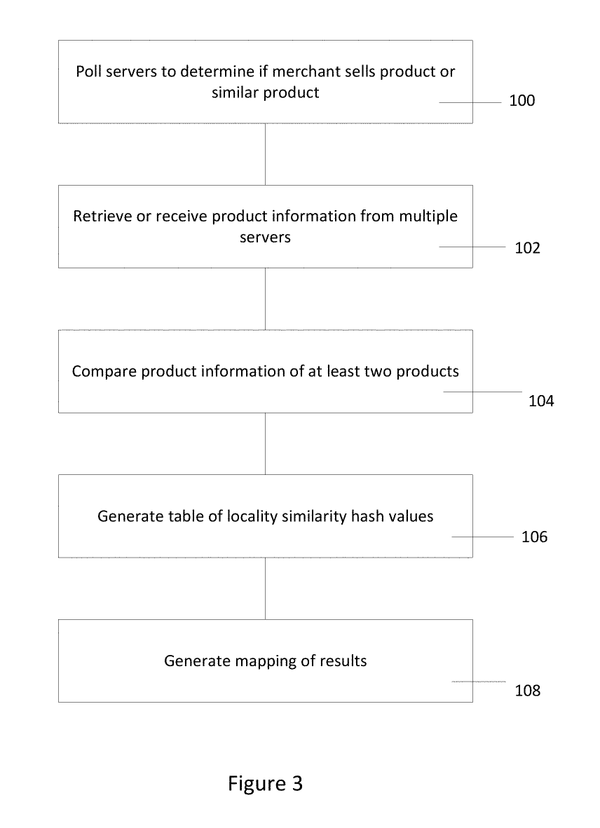

Turning to FIG. 3, a flowchart outlining a method of clustering products in an electronic commerce environment is shown. It is assumed that within each server 12 that is associated with a merchant 14 is a listing of products along with a set of characteristics associated with each product. It is preferred that the set of characteristics be common between all merchants 14 (and like products), however, there may need to be some processing of the product information by the processor in order to align all of the characteristics. In one embodiment, the set of characteristics may include, but are not limited to, name, description, price, manufacturer, UPC code or image. As will be understood, the product and each of the set of characteristics may be stored in a table format within each of the servers 12. The beginning of the example below assumes that there is no information stored in the database relating to the product being searched.

Based on a request from a user, or, based on a need to cluster products, the servers 12 are polled, such as by the processing system 15, to determine if the merchant sells the product (or similar products) (100) and, if so, may request the product information relating to the product from the associated server. In some cases, a single merchant may have multiple similar products and may deliver multiple sets of characteristics to the processing system 15. For example, if the search request is for a 50 inch television by a specific manufacturer, other 50 inch televisions by other manufacturers may be seen as a similar product or other similarly sized televisions may be seen as similar products.

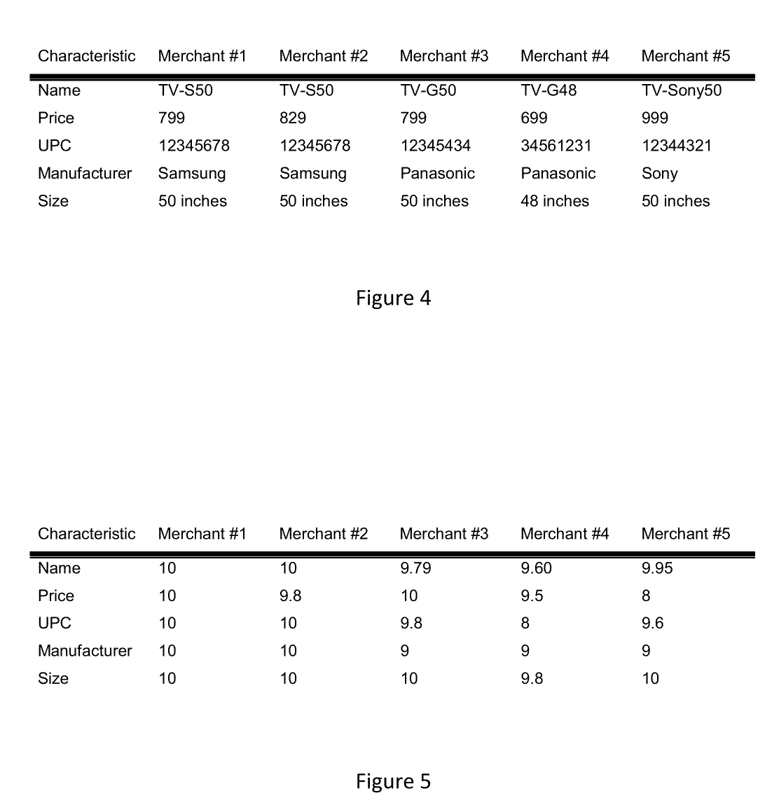

The product information relating to the same or similar product is then retrieved or received by the processing system 15 from the relevant servers 12 (102). This is preferably performed by the communication module 24. An example of a table generated by the system from retrieved product information is schematically shown in FIG. 4. In an alternative embodiment, the product information may be previous shared by the merchants and stored in the database (such as in the format of the table of FIG. 4) and simply retrieved from the database for clustering of products.

A comparison is then performed between the product information of at least two products (104). This may be performed one at a time between two products or multiple products may be compared at the same time with each other (or to a single product). In one embodiment, each of the set of characteristics of two products is compared with each other. In another embodiment, the set of characteristics from multiple merchants may be compared with a single product. In another embodiment, the set of characteristics of each product may be compared to a predetermined search string, or search text.

For instance, the products listed in FIG. 4 showing Merchants 2 to 5 may be compared with the set of characteristics of Merchant 1 in order to cluster those products with the product of Merchant 1. It is assumed that the only product in the database is the product listed under Merchant 1. In the table of FIG. 4, it will be understood that the Merchants may be different merchants or may be the same merchant selling two different, but similar, products. Any comparison methodology such as a Jaccard comparison, or Jaccard Index, can be used for this comparison. The Jaccard Index can be seen as an Intersection over a Union and typically results in a Jaccard similarity co-efficient.

Since all of the products are being compared to the one from Merchant 1, the search string for Name=TV-S50, the search for Price=799, the search string for UPC=12345678, the search string for Manufacturer=Samsung and the search string for Size=50 inches, or in other words, the set of characteristics listed under Merchant 1. The characteristics obtained from the product information from Merchants 2 to 5 are then compared with this information and a weighting value or Jaccard similarity co-efficient is generated. A table of locality similarity hash values, such as in the form of Jaccard co-efficients, can then be generated based on the comparison or comparisons (106). In one embodiment, these values may be seen as locality similarity hash values. An example table showing locality similarity hash values is provided in FIG. 5. In some embodiments, the difference between the locality similarity hash values can be larger as the numbers may be spread out on an axis with over two billion numbers. As will be understood, a table showing different numbers may be generated depending on the comparison methodology that is used for the comparison, however, these values represent how similar each set of characteristics is to each other.

As can be seen, using the set of characteristics from Merchant 1 as the search or comparison criteria, an arbitrary value of 10 is assigned when there is a direct match. The value of 10 is arbitrarily selected for explanation purposes. As can be seen, for the Name search string, since Merchant 2 has the same name, it is also assigned the value of 10. For Merchant 3, since it is a different model, “G50” rather than “S50”, the assigned value is slightly less than 10 meaning that it is close but not exact. Similar for the Name string of Merchants 4 and 5. Similar comparisons are then performed for each of the other set of characteristics. These example results are shown in FIG. 5.

In another embodiment, the table may be generated based on machine learning. After a few comparisons have been performed, machine learning such as in the form of a neural network or deep learning network or system, may be used to recognize patterns within the comparisons. In this case, the comparison may be performed using any selected comparison algorithm, however, the locality sensitive hash value can be determined without having to calculate a comparison value. In another embodiment, the weights on each characteristic can be determined by machine learning whereby the similarity between two characteristics can be calculated using any similarity or comparison methodology or algorithm such as, but not limited to, Jaccard, or a structural similarity (SSIM) (if images are being compared) or machine learned itself.

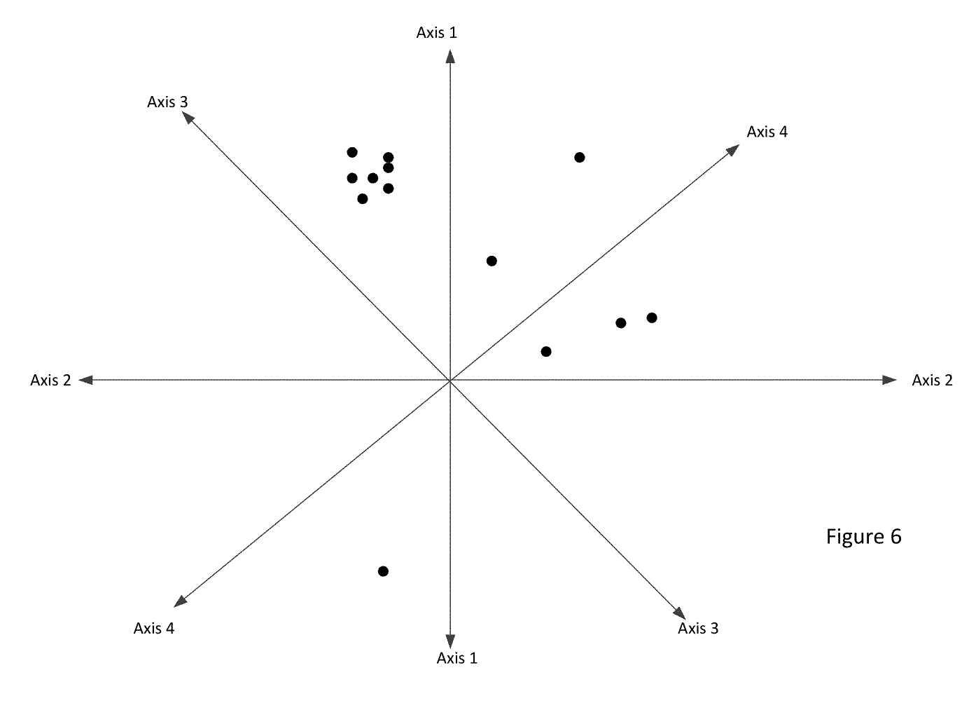

After the table of hash values has been developed, a mapping of the locality sensitive hash values is created (108) such as in an n-dimensional mapping with n representing the number of different characteristics within the set of characteristics. An example of a 4-space mapping is shown in FIG. 6. This mapping can then be used to generate reports and the like of similar products for a user to review without the system having to perform separate searches and clustering each time a request is made. This mapping may also be facilitate the addition of new products to the clustering. The generation of a virtual n-dimensional space mapping, or mapping space, will be understood by one skilled in the art. As mentioned above, the number of dimensions (n) is preferably equal to the number of characteristics being compared.

In one embodiment, the distances between the values in the table are plotted in the n-dimensional mapping space so that it can be seen which products can be or are clustered together. The mapping products a “heat map” of sorts reflecting how many products are similar and therefore clustered together. Therefore, when a user requests to see information about a specific product and any similar products, the system can review the table or the mapping space to determine which products fall within the search criteria based on the locality sensitive hash values or determines the products that are proximate the search product in the mapping space. In one embodiment, those products that are less than a distance threshold from the search product may be seen as being similar to the search product. The closer the values are to each other, the more similar the products are. As such, a new search does not have to be performed each time there is a request for a listing of similar products.

For instance, now assuming that the table of FIG. 4 has all been stored in the system, if a user wishes to search for a product (such as the one listed under Merchant 1, the system can review the map (or the table) to determine all products stored in the system that is <1 from the product in Merchant 1 for one or more of the characteristics. Alternatively, the system may display the product and similar products where none of the characteristics are >1 away.

For instance, using the >1 away criteria, it can be seen that the products for Merchants 2 and 3 would be seen as being similar products to the product of Merchant 1 but the products of Merchants 4 (UPC) and 5 (Price) would not be seen as being similar products. Therefore, when a user enters a search for the product of Merchant 1, they will be shown the products of Merchants 1 to 3. As will be understood, the rules for display may be predetermined or may be selected by the user. For instance, the user may only care for similar products that are within a certain price range and therefore, the difference in some of the other characteristics may not be important.

Alternatively, when a user is searching for a specific product, the system may refer to the map and retrieve all the products that are clustered around the specific product. The “closeness” of similar products may be determined via predetermined algorithms or all products falling within a specific distance from the specific product (in the n-dimensional mapping space may be selected).

If there are any further products to be added after the generation of the n-dimensional mapping space, the set of characteristics can be compared to any one of the set of characteristics that has previously been assigned locality sensitive hash values and, preferably by using the comparing and machined learned processes, the locality sensitive hash values for the new set of characteristics can be added to the table (FIG. 5) and then mapped to the mapping space.

Although the present disclosure has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present disclosure.

In the preceding description, for purposes of explanation, numerous details are set forth in order to provide a thorough understanding of the embodiments. However, it will be apparent to one skilled in the art that these specific details may not be required. In other instances, well-known structures may be shown in block diagram form in order not to obscure the understanding. For example, specific details are not provided as to whether elements of the embodiments described herein are implemented as a software routine, hardware circuit, firmware, or a combination thereof.

Embodiments of the disclosure or components thereof can be provided as or represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor or controller to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor, controller or other suitable processing device, and can interface with circuitry to perform the described tasks.

What is claimed is:

1. A method of clustering a plurality of products in an electronic commerce (e-commerce) environment comprising:
comparing a set of characteristics associated of a selected product with a set of characteristics of each of the other plurality of products;
determining a set of locality sensitive hash values for the selected product based on the set of characteristics of the other plurality of products; and
mapping the first product based on the set of locality sensitive hash values on a n-dimensional mapping space;
wherein n is equal to a number of characteristics in the set of characteristics.

2. The method of claim 1 wherein comparing a set of characteristics comprises:
comparing each of the set of characteristics using a Jaccard comparison or a Jaccard Index.

3. The method of claim 1 further comprising, before comparing a set of characteristics:
receiving a request for the selected product to be searched.

4. The method of claim 3 further comprising, after receiving the request:
retrieving the set of characteristics of each of the other plurality of products.

5. The method of claim 4 wherein retrieving comprises:
retrieving the set of characteristics from a set of merchant servers.

6. The method of claim 4 wherein retrieving comprises:
retrieving the set of characteristics from a database.

7. The method of claim 1 further comprising:
displaying the n-dimensional mapping space to a user.

8. The method of claim 1 further comprising:
polling a set of merchant servers to retrieve the set of characteristics of the other plurality of products.

9. A system for clustering a plurality of products in an electronic commerce (e-commerce) environment comprising:
a memory component comprising one or more modules executable by one or more processors, the one or more modules comprising:
a communication module for communicating with users and merchants; and
a clustering module for comparing a product with the plurality of products to generate a set of locality sensitive hash values and to map the set of locality sensitive hash values to an n-dimensional space mapping.

10. The system of claim 9 wherein the memory component further comprises:
a display module for displaying search results to a user.

11. The system of claim 9 further comprising a database for storing data from the clustering module.

12. The system of claim 9 further comprising a mapping module for mapping the set of locality sensitive hash values to an n-dimensional space mapping.
